(19) United States
(12) Patent Application Publication
(10) Pub. No.: US 2016/0192681 A1
(43) Pub. Date: Jul. 7, 2016

(54) READY TO EAT OATMEAL COMPOSITION AND METHOD OF DELIVERY

(71) Applicant: Munk Pack Inc., Greenwich, CT (US)

(72) Inventors: Tobias Glienke, Greenwich, CT (US); Michelle Leutzinger, Greenwich, CT (US)

(73) Assignee: Munk Pack Inc., Greenwich, CT (US)

(21) Appl. No.: 14/988,483

(22) Filed: Jan. 5, 2016

Related U.S. Application Data
(60) Provisional application No. 62/099,754, filed on Jan. 5, 2015.

(51) Int. Cl. A23L 1/164; B65D 85/72

(52) U.S. Cl. CPC A23L 1/1646; B65D 85/72; A23V 2002/00

(57) ABSTRACT

The ready-to-eat oatmeal compositions of the present disclosure comprise oat grains, water, and fruit. The composition can be eaten after having been stored at room temperature, and can be consumed without the use of any utensils or the need to add any other ingredients, delivered directly through the spout by squeezing the system for delivery. The composition may be stored in a system for delivery comprising a flexible pouch. The dry, uncooked oat grains may have a thickness of from 0.020 inches to 0.070 inches. The fruit can be in at least one of the forms of puree, juice concentrate, dehydrated fruit solids, or diced. The composition may include optional ingredients such as acid or seeds. The present disclosure also comprises methods of delivery of the compositions to a consumer thereof.

### CROSS-REFERENCE TO RELATED APPLICATIONS

The present application claims the benefit of U.S. Provisional Patent Application Ser. No. 62/099,754, filed on Jan. 5, 2015, which is herein incorporated by reference.

### BACKGROUND OF THE DISCLOSURE

The present disclosure relates to oatmeal compositions, methods of delivery thereof, and systems for delivery thereof. More particularly, the present disclosure relates to ready-to-eat oatmeal compositions that can be stored at room temperatures and that do not require the addition of any additional component before consumption, the method of delivery of the composition, and the system for delivery of the composition, which comprises a container containing the composition.

There are several oatmeal products available commercially at this time. However, many of these products require the use of bulky or inconvenient containers. Furthermore, current compositions or products require that an additional component, such as water, be added before consumption. Current compositions or products also require utensils to achieve ingestion of the compositions or products. Such compositions or products can thus be inconvenient at times, for example when the user may be on-the-go or conducting recreational activity. Lastly, current ready-to-eat products may have artificial sweeteners or preservatives, which are undesirable to users, or may require refrigeration. Other ready-to-eat products that claim to contain oatmeal are merely smooth purees that lack oatmeal texture.

The present disclosure addresses these deficiencies.

### SUMMARY OF THE DISCLOSURE

The present disclosure provides a ready-to-eat oatmeal composition that advantageously and conveniently does not require the addition of any other substances or use of any other utensils before consumption. In one embodiment, the compositions can be stored in a system for delivery of the composition, comprising a flexible pouch with a narrow spout, so that a user can eat the composition directly from the pouch without any utensils. The composition can be stored at room temperature. The ready-to-eat oatmeal composition of the present disclosure, which comprises oats, water, and fruit, was not previously available.

In one embodiment, the present disclosure provides a ready-to-eat oatmeal composition, comprising oat grains, fruit, and water. The oat grains can be rolled, flaked, or cut, and can have a thickness of between 0.020 inches and 0.070 inches, and any subranges therebetween. The oat grains can also be present in an amount of two to ten percent by weight of the total composition. The fruit is in the form of at least one selected from the group of a puree, a juice concentrate, or a dehydrated solid.

The present disclosure also provides a container having the composition of the present disclosure stored therein. The container comprises a flexible body portion having an interior space for storing the composition, a spout in fluid communication with the interior space, and a cap for selectively covering said spout. The flexible body of the container may be a flexible pouch to squeeze the composition out of the spout directly into the consumer's mouth, e.g., by manual compression.

The present disclosure also provides methods of delivery of the ready-to-eat oatmeal composition.

### BRIEF DESCRIPTION OF THE DRAWINGS

FIG. 1 shows an embodiment of the present disclosure comprising a container in the form of a pouch that can store the ready-to-eat oatmeal composition of the present disclosure.

### DETAILED DESCRIPTION OF THE DISCLOSURE

The ready-to-eat oatmeal compositions of the present disclosure comprise thick-cut oat grains, fruit, water, and several optional ingredients discussed below. The oat grains are cut or rolled to a thickness and are present in an amount so that they retain an oatmeal-like texture, but can be packaged easily. The combination of oat grains, water, and fruit as described below provides for a composition that can be packaged and consumed easily via a system for delivery, without the need for artificial preservatives or eating utensils. The composition is shelf-stable, can be stored at room temperature for an extended period of time within the system for delivery, and does not need to be heated by a user before consumption. This presents several advantages over currently available products.

The uncooked, dry oats of the present disclosure have thickness ranges as follows: from twenty thousandths of an inch (0.020 inches) to seventy thousandths of an inch (0.070 inches), or any subranges therebetween, from twenty-six thousandths of an inch (0.026 inches) to sixty-one thousandths of an inch (0.061 inches), or any subranges therebetween, from thirty thousandths of an inch (0.030 inches) to forty-two thousandths of an inch (0.042 inches), or any subranges therebetween, from thirty thousandths of an inch (0.030 inches) to thirty-four thousandths of an inch (0.034 inches), or any subranges therebetween, from thirty-two thousandths of an inch (0.032 inches) to forty-one thousandths of an inch (0.041 inches), or any subranges therebetween, from forty-five thousandths of an inch (0.045 inches) to seventy thousandths of an inch (0.070 inches), or any subranges therebetween, and from thirty thousandths of an inch (0.030 inches) to seventy thousandths of an inch (0.070 inches), or any subranges therebetween. In one embodiment, the oat grains are rolled to the desired thickness. The oat grains of the present disclosure can also be prepared by other methods than rolling, such as cutting, milling, or flaking. The oat grains can also be pre-treated with heat to minimize additional absorption of moisture, in order to retain their form and texture in the finished product.

Without being bound by theory, it is believed that at oak thicknesses of larger than seventy thousandths of an inch (0.070 inches), the other components of the composition with which the oats are prepared do not sufficiently penetrate the oat grain to offer preservative properties. That is, because the acids from the fruits or other components described below provide preservative properties, if the oat grain is too thick, it may not be preserved properly. At oat thicknesses of less than twenty thousandths of an inch (0.020 inches), the texture of the oat begins to break down, and it loses its structure or takes on a mealy feel. Thus, the present disclosure has determined that the above-discussed thickness ranges are particularly suitable for a ready-to-eat composition.

The amount of oat grains in the composition of the present disclosure is also important to maintain the desired texture. In one embodiment, the amount of oat grains can be from two to ten percent by weight of the total composition, or any subranges therebetween. In another embodiment, the amount of oat can be from four to nine percent by weight of the total composition, or any subranges therebetween. In another embodiment, the amount of oat can be from 5.6 to 7.8 percent by weight of the total composition, or any subranges therebetween. As used in the present disclosure, the term “oat grains” or “grains” refers to the dry grains before mixing with water and/or fruit. The term “oatmeal” refers to the mixture of grains with water and other ingredients.

The compositions of the present disclosure also contain water. The amount of water should be tailored to the amount of grains described above, to provide the desired oatmeal-like consistency. The amount of water in the present compositions will always be fifty percent or less, based on the total weight of the composition. One suitable ratio of water to oat grains is two parts water to one part rolled oats by volume. This translates to an approximately 4.93:1 by weight ratio of water to oat grain. The present disclosure contemplates broader ranges and ratios of water to oat grain. When the fruit puree source is especially fluid, then less water may be used. Conversely, when the fruit puree is especially thick, more water may be used.

The fruit in the compositions of the present disclosure can be in one or more of four forms. In the first, the fruit can be a puree. As used in the present disclosure, the term fruit “puree” refers to a fruit that has been pressed, blended, crushed, and/or otherwise broken down so that it has the texture of a smooth, soft, semi-liquid or paste. This is distinguished from other forms of fruit such as diced or dried fruit. Diced fruit and dried fruit have some rigidity or structure to the fruit that is predominantly absent in a puree. The puree may retain residual fruit pieces. As discussed in greater detail below, in addition to the desirable texture, a fruit puree can be particularly advantageous when the compositions of the present disclosure are packaged.

The fruit puree of the present disclosure may be present in an amount of ten to ninety-eight percent based on the total weight of the composition, or any subranges therebetween. In another embodiment, the amount of fruit puree is sixteen percent or greater by weight of the total composition.

As used in the present disclosure, a “concentrate” is a fluid where all or most of the base solvent has been removed. Thus, a fruit concentrate is a fruit juice where most or all of the water has been removed. In the present disclosure a fruit juice concentrate, when present, can be present in an amount of nine percent or less, based on the total weight of the composition, or any subranges thereof. In another embodiment, when present, the fruit juice concentrate is present in an amount of three to six percent, based on the total weight of the composition, or any subranges therebetween.

Dehydrated fruit solids refer to whole or partial fruits that have been dried. Diced fruit refers to fruit solids that have been cut into pieces that are smaller than bite-sized. In one embodiment, when present, the dehydrated fruit solids or diced fruit can be present in an amount of ten to ninety-eight percent based on the total weight of the composition, or any subranges therebetween. In another embodiment, when present, the dehydrated fruit solids or diced fruit can be present in an amount of one to five percent based on the total weight of the composition, or any subranges therebetween.

The fruit may be present in one or more, or two or more, of the above-described forms. For example, the composition can contain fruit puree and fruit juice concentrate and/or dehydrated fruit solids or diced fruit. In another embodiment, the fruit can be present in all four forms, namely puree, concentrate, dehydrated fruit solids, and diced fruit. The types of fruit suitable for use in the present disclosure are not particularly limited. Fruits contemplated by the present disclosure include, but are not limited to, apples, bananas, pears, blueberries, blackberries, strawberries, raspberries, cherries, acai, coconuts, mangos, passion fruits, lemons, oranges, grapefruits, and any combinations thereof.

The present disclosure also contemplates other optional ingredients that may be included in the oatmeal composition. For example, depending on the type of fruit needed, additional acid may be needed to drive the pH of the composition down before pasteurization. In one embodiment, the pH of the composition is lowered to 4.2 or lower before pasteurization. Suitable acids may include, but are not limited to, citric acid, ascorbic acid, lemon juice, lemon juice concentrate, or combinations thereof. The amount of acid needed can depend on several factors. The type of acid used, the type of fruit used, and the acidity of a particular batch of fruit can all affect how much acid will need to be added when it is present.

The composition of the present disclosure may also include ground nuts, or seeds such as flax, chia, hemp, sunflower, sesame, or poppy, either as whole seeds, ground seeds, or as extracts. The amount of nuts or seeds may be up to approximately six percent by weight of the total composition. In another embodiment, the amount of nuts or seeds is from approximately 0.3 to five percent by weight of the total composition, or any subranges therebetween.

Sweeteners, either natural or synthetic, may also be added to the composition, in an amount of up to approximately six percent by weight of the composition, or subranges therebetween. Plant sterols also may be added.

With some of the above-described fruits, nuts, and seeds, it may be possible to add enough to achieve a similar amount of texture and mouth-feel as the oat grains. For example, a sufficient amount of coconut or apple could be used to create the desired texture of oat grains or oatmeal. In this case, the coconut (or other fruit) could replace some or all of the amount of oat grains described above. Thus, in one embodiment, the present disclosure contemplates a composition without any oat grains at all, and amounts of fruit equal to or higher than described above. The present disclosure also contemplates a composition where the amount of oat grains is lower than what is described above, and amounts of dehydrated fruit and/or seeds are higher than what is described above.

The compositions of the present disclosure are also advantageous in the ingredients that are excluded. For example, the oats and/or the overall composition may be gluten-free. As used in the present disclosure, the term “gluten-free” means less than forty parts per million of gluten, or less than twenty parts per million of gluten. The compositions of the present disclosure may also have no added salt. As used in the present disclosure, “salt-free” means less than 0.04 percent by weight of the composition of added salt. In another embodiment, the composition of the present disclosure is vegan, meaning that no animal products are present. This includes animal proteins, as well as egg products, or dairy or milk solids. The compositions may also be free of any sweeteners other than the fruits described above, and may also be free of plant sterols. Lastly, the compositions of the present disclosure may be free of any synthetic preservatives.

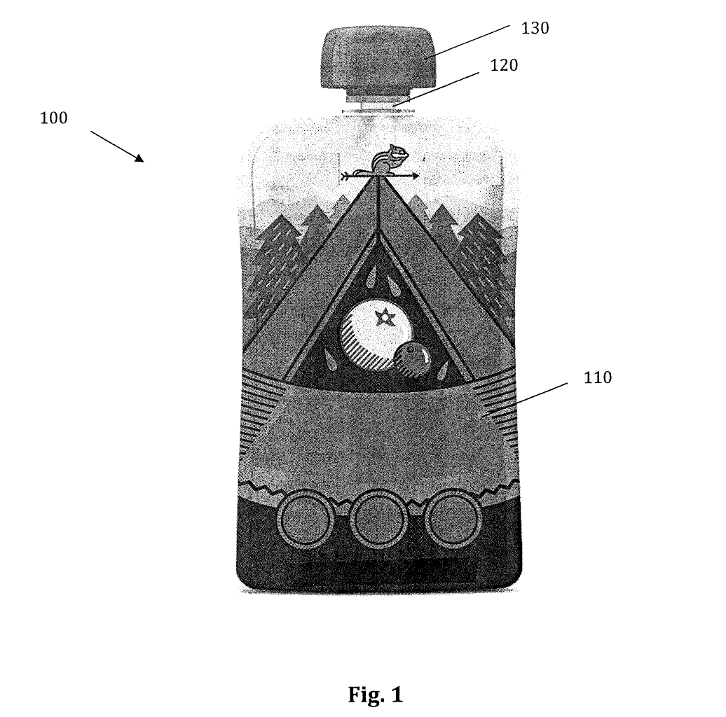

Referring to FIG. 1, a system for delivery of the compositions of the present disclosure in the form of a container suitable for holding the composition of the present disclosure is shown, and referred to with numeral 100. Container 100 has body 110 with an interior space to hold the ready-to-eat oatmeal composition described above. Container 100 also has neck or spout 120, and cap 130. The composition is consumed directly out of the body 110 through spout 120. In one embodiment, container 100 is not microwaveable. Container 100 can be submerged in hot or boiling water to heat the composition, if desired.

Again, the composition of the present disclosure is distinguished from currently available products in that it has oat grains and fruit, does not require the addition of any other ingredients (e.g., hot water), does not require the use of utensils, and can be stored at room temperature within the system for delivery of the composition. Furthermore, body 110 can be a flexible pouch made of plastic and/or metal film. This provides significant advantages for storage and/or carrying of the system for delivery in the form of container 100. Many current food products are sold in rigid plastic containers that are bulky and unwieldy.

The diameter of spout 120 is between five millimeters and thirty-five millimeters, or any subranges therebetween. The spout diameter and consistency of the composition are designed for each other in that the composition is easily filled through spout 120 in the manner described below. Other currently available compositions might use diced fruit that is too large to add or fill through a narrow spout. By contrast, the fruit puree, concentrate, dehydrated fruit solids, and diced fruit described herein are processed in such a manner to pass through spout 120. The puree, concentrate, dehydrated fruit solids, and diced fruit described herein can be prepared or processed independently and/or combined during said processing.

To fill the ready-to-eat oatmeal composition of the present disclosure into the system for delivery in the form of container 100, the ingredients described above (oats, water, fruit, optional ingredients) are mixed and pre-heated, to wet and soften them. This mixing and pre-heating allows for pH adjustment and a proper flow of ingredients through the processing system and spout 120. In some processing systems, a mesh screen is used as a filter of unwanted materials. In one embodiment, if a screen is in place, the screen mesh openings are at least 5 mm or larger, to minimize breakdown of the oat, fruit, and other particulates that contribute texture. The mixture can be heated in a kettle or heat exchanger, and the temperature can be such that the mixture is pasteurized. The mixture can then be filled into body 110. After filling, the body 110 may be heated further in a post-pasteurization process.

The oats and dehydrated fruit (when used) in the present composition may expand further in body 110 after the filling process. In this way, the structural integrity of the oats and fruit can be largely maintained as the ingredient mixture described above is filled through spout 120 into body 110. By contrast, in other currently available products, uncooked dry oats are added to a container, and then mixture of other heated ingredients is added. Filling dry, uncooked ingredients into the body 110 through spout 120 is not suitable, as uncooked, dry ingredients will likely clog spout 120. Further, proper mixing of uncooked, dry oats with other heated ingredients, once filled through spout 120 into body 110, will be a challenge and could adversely affect food safety and shelf-stability. In this way, the present disclosure provides a shelf-stable composition wherein all of the individual ingredients maintain their structural integrity as ingredients are filled through spout 120 into body 110.

In another embodiment, the present disclosure comprises a method of delivery of the compositions of the present disclosure to a consumer thereof using a system for delivery described herein, comprising: (a) removing the cap of the system for delivery; (b) bringing the spout of the system for delivery to the lips of the consumer; (c) squeezing and optionally tilting the container of the system for delivery to produce or effect movement of the composition into the mouth of the consumer, preferably using manual compression; (d) removing the container of the system for delivery from the lips of the consumer; and (e) repeating steps (b) through (d) until ingestion or consumption of the composition is complete. Optionally, the method of delivery may comprise squeezing the flexible body portion of the container using manual compression for delivery between or during repetitions of steps (b) through (d) of the method of delivery recited above. Optionally, the method of delivery may comprise heating the container of the system for delivery either by microwave or submersion in water of elevated temperature prior to step (a) of the method of delivery recited above.

It is noted that compression/squeezing is a key part of the delivery method because in order for the particulates and thickness of the composition to pass through the spout, some compression may be necessary. Therefore, squeezing/compressing the flexible packaging is the primary means of delivering the compositions described herein. Further, some negative pressure or sucking of the composition into the mouth can be employed by the user in conjunction with chewing or masticating.

Although the present compositions are described as containing oat grains, the present disclosure also contemplates other grains (including ancient grains) for use in the present disclosure to create a similar oatmeal-like consistency. For example, in place of or in combination with oat grains, the compositions of the present disclosure may contain quinoa, teff, amaranth, maize, rice, wheat, barley, sorghum, millet, rye, triticale, buckwheat, fonio, or any combinations thereof.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

1. A ready-to-eat oatmeal composition, comprising:
oat grains;
fruit; and
water.

2. The composition of claim 1, wherein said oat grains are rolled and have a thickness of between 0.020 inches and 0.070 inches.

3. The composition of claim 1, wherein said oat grains are rolled and have a thickness of between 0.026 inches and 0.061 inches.

4. The composition of claim 1, wherein said oat grains are rolled and have a thickness of between 0.030 inches and 0.042 inches.

5. The composition of claim 1, wherein said oat grains are present in an amount of two to ten percent by weight of the total composition.

6. The composition of claim 1, wherein said oat grains are present in an amount of four to nine percent by weight of the total composition.

7. The composition of claim 1, wherein said water is present in an amount of fifty percent or less, by weight of the total composition.

8. The composition of claim 1, wherein said fruit is in the form of at least one selected from the group of a puree, a juice concentrate, a dehydrated solid, or diced.

9. The composition of claim 8, wherein said fruit is a puree, present in an amount from ten to ninety-eight percent, by weight of the total composition.

10. The composition of claim 8, wherein said fruit is a concentrate, present in an amount of nine percent or less, by weight of the total composition.

11. The composition of claim 8, wherein said fruit is a dehydrated fruit solid, present in an amount of one to five percent, by weight of the total composition.

12. The composition of claim 8, wherein said fruit is diced, present in an amount of one to five percent, by weight of the total composition.

13. The composition of claim 1, further comprising an acid.

14. The composition of claim 1, wherein the composition is vegan.

15. The composition of claim 1, wherein the composition is free of added sweeteners or salt.

16. A system for delivery of the composition of claim 1, comprising a container having the composition stored therein.

17. The system for delivery of claim 16, wherein the container further comprises:
a flexible body portion having an interior space for storing the composition;
a spout in fluid communication with said interior space; and
a cap for selectively covering said spout.

18. The system for delivery of claim 17, wherein the flexible body portion is a flexible pouch.

19. A ready-to-eat oatmeal composition, comprising:
oat grains, wherein said oat grains have a thickness of between 0.020 inches and 0.070 inches, and wherein said oat grains are present in an amount of two to ten percent by weight of the total composition;
fruit, wherein said fruit is in the form of at least one selected from the group of a puree, a juice concentrate, a dehydrated solid, or diced; and
water, present in an amount of fifty percent or less, by weight of the total composition.

20. The composition of claim 1, wherein said oat grains are rolled and have a thickness of between 0.030 inches and 0.041 inches.

21. The composition of claim 19, wherein said fruit is a puree, present in an amount from ten to ninety-eight percent, by weight of the total composition.

22. The composition of claim 19, wherein said fruit is a juice concentrate, present in an amount of nine percent or less, by weight of the total composition.

23. The composition of claim 19, wherein said fruit is a dehydrated fruit solid, present in an amount of one to five percent, by weight of the total composition.

24. The composition of claim 19, wherein said fruit is diced, present in an amount of one to five percent, by weight of the total composition.

25. The composition of claim 19, further comprising an acid.

26. The composition of claim 19, wherein the composition is vegan.

27. The composition of claim 19, wherein the composition is free of added sweeteners or salt.

28. A system for delivery of the composition of claim 19, comprising a container having the composition stored therein.

29. The system for delivery of claim 28, wherein the container further comprises:
a flexible body portion having an interior space for storing the composition;
a spout in fluid communication with said interior space; and
a cap for selectively covering said spout.

30. The system for delivery of claim 29, wherein the flexible body portion is a flexible pouch.

31. A method of delivery of a ready-to-eat oatmeal composition to a consumer, said composition comprising oat grains; fruit; and water, said composition stored in a container comprising a flexible body portion having an interior space for storing the composition; a spout in fluid communication with said interior space; and a cap for selectively covering said spout, comprising the steps of:
(a) removing the cap of the container;
(b) moving the spout of the container to the lips of the consumer;
(c) squeezing the flexible body portion of the container using manual compression to produce movement of the composition into the mouth of the consumer through the spout;
(d) removing the container from the lips of the consumer; and
(e) optionally repeating steps (b) through (d) until consumption of the composition is complete.

32. The method of delivery of claim 31, further comprising heating of the container prior to removing the cap of the container.

33. The method of delivery of claim 31, further wherein squeezing the flexible body portion of the container using manual compression is carried out before or during repetitions of steps (b) through (d).

34. The method of delivery of claim 31, further wherein squeezing the flexible body portion of the container using manual compression is accompanied by simultaneous tilting of the flexible body into the mouth of the consumer through the spout.

35. A method of delivery of a ready-to-eat oatmeal composition to a consumer, said composition comprising: oat grains, wherein said oat grains have a thickness of between 0.020 inches and 0.070 inches, and wherein said oat grains are present in an amount of two to ten percent by weight of the total composition, fruit, wherein said fruit is in the form of at least one of a puree, a juice concentrate, a dehydrated solid, or diced, and water, present in an amount of fifty percent or less, by weight of the total composition, said composition stored in a container comprising a flexible body portion having an interior space for storing the composition; a spout in fluid communication with said interior space; and a cap for selectively covering said spout, comprising the steps of:
(a) removing the cap of the container;
(b) moving the spout of the container to the lips of the consumer;
(c) squeezing the flexible body portion of the container using manual compression to produce movement of the composition into the mouth of the consumer through the spout;
(d) removing the container from the lips of the consumer; and
(e) optionally repeating steps (b) through (d) until consumption of the composition is complete.

36. The method of delivery of claim 35, further comprising heating of the container prior to removing the cap of the container.

37. The method of delivery of claim 35, further wherein squeezing the flexible body portion of the container using manual compression is carried out before or during repetitions of steps (b) through (d).

38. The method of delivery of claim 35, further wherein squeezing the flexible body portion of the container using manual compression is accompanied by simultaneous tilting of the flexible body into the mouth of the consumer through the spout.
